(19) United States
(12) Patent Application Publication
(10) Pub. No.: US 2025/0300211 A1
(43) Pub. Date: Sep. 25, 2025

(54) SECONDARY BATTERY MANUFACTURING DEVICE AND SECONDARY BATTERY MANUFACTURING METHOD

(71) Applicant: SK ON CO., LTD., Seoul (KR)

(72) Inventors: Joong Hyeon AHN, Daejeon (KR); Sang Ho LEE, Daejeon (KR)

(21) Appl. No.: 19/088,998

(22) Filed: Mar. 25, 2025

(30) Foreign Application Priority Data
Mar. 25, 2024 (KR) 10-2024-0040492
Feb. 7, 2025 (KR) 10-2025-0016036

(51) Int. Cl. H01M 10/04

(52) U.S. Cl. CPC H01M 10/0409; H01M 10/0431; H01M 10/0481

(57) ABSTRACT

A secondary battery manufacturing device according to various embodiments of the present disclosure may include: a holding device configured to elastically support an electrode assembly; an clastic member which is disposed on one side of the holding device to apply an elastic force to the holding device; and a first sensing member configured to detect an clastic force applied by the clastic member.

### CROSS-REFERENCE TO RELATED APPLICATION

This patent application claims the priority and benefits of Korean patent application No. 10-2024-0040492, filed on Mar. 25, 2024 and No. 10-2025-0016036, filed on Feb. 7, 2025, the disclosure of which is incorporated herein by reference in its entirety.

### BACKGROUND

### 1. Field of the Invention

The present disclosure relates to a device for manufacturing a secondary battery (hereinafter, also referred to as a “secondary battery manufacturing device”) and a method for manufacturing a secondary battery (hereinafter, also referred to as a “secondary battery manufacturing method”).

### 2. Description of the Related Art

Various types of secondary batteries are used as energy sources in electric vehicles or electronic machines. The secondary batteries use a jelly-roll type electrode assembly in which anode plates, cathode plates and separation membranes are wound together. Alternately, an electrode assembly fabricated by stacking anode plates, cathode plates and separation membranes in a predetermined order may also be used.

These electrode assemblies are accommodated inside a battery housing and connected to an anode terminal and a cathode terminal, then the interior of the housing is sealed while being filled with an electrolyte.

### SUMMARY

An embodiment of the present disclosure is to provide a device for manufacturing a secondary battery and a method for manufacturing a secondary battery, which are capable of preventing performance degradation of a carrier that transports the secondary battery.

According to an aspect of the present disclosure, there is provided a device for manufacturing a secondary battery including: a holding device configured to elastically support an electrode assembly; an elastic member which is disposed on one side of the holding device to apply an elastic force to the holding device; and a first sensing member configured to detect an elastic force applied by the elastic member.

In an exemplary embodiment, the holding device may include: a base unit including a base plate on which the electrode assembly is mounted; and a cover unit including a cover plate which is disposed on an upper side of the base plate to elastically press the electrode assembly.

In an exemplary embodiment, the cover plate may be disposed to move vertically relative to the base plate.

In an exemplary embodiment, the elastic member may have one end coupled to one side of the base unit, and the other end coupled to one side of the cover unit.

In an exemplary embodiment, the elastic member may include a tension spring.

In an exemplary embodiment, the holding device may include a stopper configured to regulate downward movement of the cover plate.

In an exemplary embodiment, the cover plate may be disposed to move between a first position where it presses the electrode assembly and a second position where it releases the pressing on the electrode assembly, and the first sensing member may detect the elastic force of the elastic member at the second position.

In an exemplary embodiment, the device may include a driving unit disposed on an upper side of the holding device to move the cover plate up and down by driving.

In an exemplary embodiment, the elastic member may be positioned between the driving unit and the cover plate, and the first sensing member may detect the elastic force of the elastic member as the cover plate moves upward relative to the base plate.

In an exemplary embodiment, the cover plate may elastically support the electrode assembly through a compressive elastic force exerted by the elastic member.

In an exemplary embodiment, the holding device may be provided to transport the electrode assembly while elastically supporting it.

In an exemplary embodiment, the device may include a controller configured to monitor results detected by the first sensing member.

In an exemplary embodiment, the controller may compare the elastic force of the elastic member, which is detected by the first sensing member, with a preset elastic force management standard and generate an alarm indicating whether an abnormality occurs in the elastic member.

In an exemplary embodiment, the device may include a second sensing member configured to detect a positional misalignment of the electrode assembly supported by the holding device.

In an exemplary embodiment, the controller may set the elastic force management standard based on the detection results from the first sensing member and the second sensing member.

According to another aspect of the present disclosure, there is provided a method for manufacturing a secondary battery including: moving, by a driving unit, a cover plate of a holding device to a preset position; detecting, by a first sensing member, an elastic force of an elastic member which is tensioned according to the movement of the cover plate; comparing, by a controller, a detection result detected by the first sensing member with a preset elastic force management standard to determine whether an abnormality occurs in the elastic member.

In an exemplary embodiment, the method may include detecting, by a second sensing member, a positional misalignment of the electrode assembly elastically supported by the holding device.

In an exemplary embodiment, the method may include setting, by the controller, the elastic force management standard based on the detection results from the first sensing member and the second sensing member.

In an exemplary embodiment, the method may include generating, by the controller, an alarm based on the abnormality determination result of the elastic member.

The secondary battery manufacturing device according to various embodiments of the present disclosure may prevent defects that occur during the fixation of the electrode assembly.

In addition, the secondary battery manufacturing device of the present disclosure may detect a decrease in the fixation force of the electrode assembly, thereby preventing fixation defects in advance.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 and 2 are side views of a secondary battery manufacturing device according to exemplary embodiments of the present disclosure;

FIG. 3 is a cross-sectional view illustrating a holding device according to an exemplary embodiment of the present disclosure;

FIG. 4 is a perspective view illustrating a driving unit and a first sensing member according to an exemplary embodiment of the present disclosure;

FIG. 5 is a block diagram illustrating the operational relationship between some components according to an exemplary embodiment of the present disclosure;

FIG. 6 is a graph illustrating the standard deviation of result data detected by a second sensing member for each elastic member;

FIG. 7 is a graph illustrating the correlation between the detection result data from the first sensing member and the detection result data from the second sensing member for a plurality of elastic members with different elastic forces; and

FIGS. 8 and 9 are flowcharts illustrating sequences of a secondary battery manufacturing method according to various embodiments of the present disclosure.

### DETAILED DESCRIPTION OF THE INVENTION

The embodiments of the present disclosure are provided to more fully describe the present disclosure to those skilled art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe his or her invention, they should be interpreted based on the meanings and concepts that meet the technical ideas of the present disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, theses terms should be construed to imply that the presence of corresponding component, and thus should not be interpreted to exclude the presence of other components but rather to include them.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected” or “coupled” to another component, the component may be directly connected or coupled to the other component, but it may be “connected” or “coupled” to the other component intervening another component may be present.

Space-related terms such as “beneath,” “below,” “lower,” “above,” and “upper” may be used to facilitate understanding of the relationship between an element or feature and another element or feature illustrated in the drawings. These space-related terms are provided to facilitate understanding of the present disclosure in their various process or usage states and are not intended impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” or “below” depending on orientation.

The embodiments described in this specification and the configurations illustrated in the drawings merely represent the most preferred embodiments of the present disclosure but do not encompass all technical ideas of the present disclosure. Thus, it should be understood that various modifications and equivalents may be implemented at the time of filing the present application. In addition, the publicly known functions and configurations that are deemed unnecessary for clarifying the essence of the present invention will not be described.

Hereinafter, a secondary battery manufacturing device according to various embodiments of the present disclosure will be described in detail with reference to the accompanying drawings.

The secondary battery described in the present disclosure may be any type of conventional battery cell capable of converting the chemical energy of materials stored in the battery into electrical energy, and supporting multiple charge/discharge cycles.

In an exemplary embodiment, the secondary battery manufacturing device according to various embodiments of the present disclosure may include a device capable of elastically supporting or releasing the support of an electrode assembly E or a battery cell during the manufacturing process of the secondary battery.

For example, the secondary battery manufacturing device may include a transport device for fixing the electrode assembly E after completion of the stacking process and transporting it to the next process. However, it should be understood that this is merely an example, and the secondary battery manufacturing device proposed in the present disclosure may include any device for elastically supporting the electrode assembly E or the battery cell.

In an exemplary embodiment, the electrode assembly E, which is elastically supported by the secondary battery manufacturing device, may include a first electrode plate (not shown), a second electrode plate (not shown) and a separation membrane (not shown).

The first electrode plate may be either a cathode plate or an anode plate. If the first electrode plate is a cathode plate, the second electrode plate may serve as an anode plate, and if the first electrode plate is an anode plate, the second electrode plate may serve as a cathode plate.

For example, the first electrode plate may be a cathode plate. In an exemplary embodiment, the first electrode plate may include a cathode current collector in the form of a metal foil, and a cathode coating layer including a cathode active material applied to the cathode current collector. For example, the cathode current collector may include aluminum.

In an exemplary embodiment, the cathode coating layer may be an electrically conductive coating and may include a cathode active material. For example, the cathode active material may include lithium nickel manganese cobalt oxide (NMC), lithium manganese oxide (LMO), lithium iron phosphate (LFP), lithium cobalt oxide (LCO), lithium titanate (LTO), or a chalcogenide (LiTiS₂) compound, but it is not limited thereto, and any cathode active material known to those skilled in the art may be used.

In an exemplary embodiment, the first electrode plate may include a first coated part where the cathode coating layer is formed on the cathode current collector, and a first uncoated part where the cathode active material is not formed on the cathode current collector.

The second electrode plate may be either a cathode plate or an anode plate. In an exemplary embodiment, the second electrode plate may be an anode plate. In an exemplary embodiment, the second electrode plate may include an anode current collector in the form of a metal foil, and an anode coating layer including an anode active material applied to the anode current collector. For example, the anode current collector may include copper or nickel.

In an exemplary embodiment, the anode coating layer may be an electrically conductive coating, and may include an anode active material. For example, the anode active material may include silicon-based materials (e.g., metallic silicon and silicon dioxide), carbon-based materials (e.g., graphite materials, graphene-containing materials, hard carbon, soft carbon, carbon nanotubes, porous carbon, conductive carbon), tin-based materials or metal oxides, etc., but it is not limited thereto, and any anode active material known to those skilled in the art may be used.

In an exemplary embodiment, the second electrode plate may include a second coated part where an anode coating layer is formed on an anode current collector and a second uncoated part where the anode coating layer is not formed.

The separation membrane may be interposed between the first electrode plate and the second electrode plate to prevent short circuits caused by direct contact between the first electrode plate and second electrode plate. For example, the separation membrane may include an electrically insulating material. For example, the separation membrane may include a polymeric material. For example, the separation membrane may include polyethylene, polypropylene, or a combination thereof, but it is not limited thereto.

For example, the electrode assembly E may be formed by sequentially stacking the above-described first electrode plate, the separation membrane, and the second electrode plate. For example, the electrode assembly E may be provided in a Z-folding structure, but it is not limited thereto, and the electrode assembly E may be provided by being wound in a jelly-roll shape. For example, the electrode assembly E may have the first uncoated part and the second uncoated part exposed from both ends, thereby defining electrode tabs.

In order to aid in understanding the invention, it will be described that the secondary battery manufacturing device according to various embodiments of the present disclosure may elastically support the electrode assembly E, but it should be understood that it is not limited thereto, and the device may also support a battery cell including the electrode assembly E.

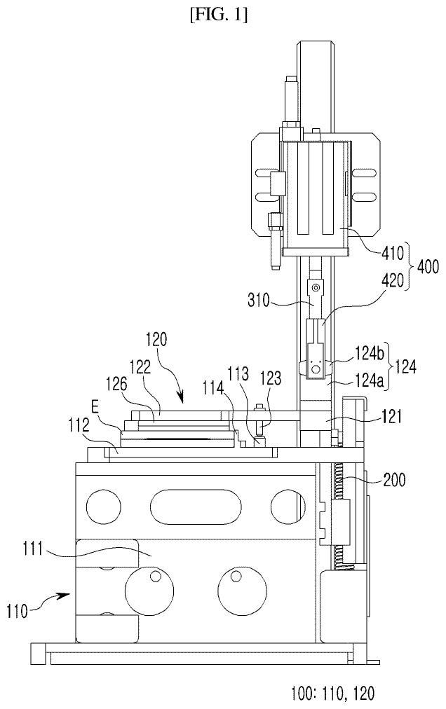

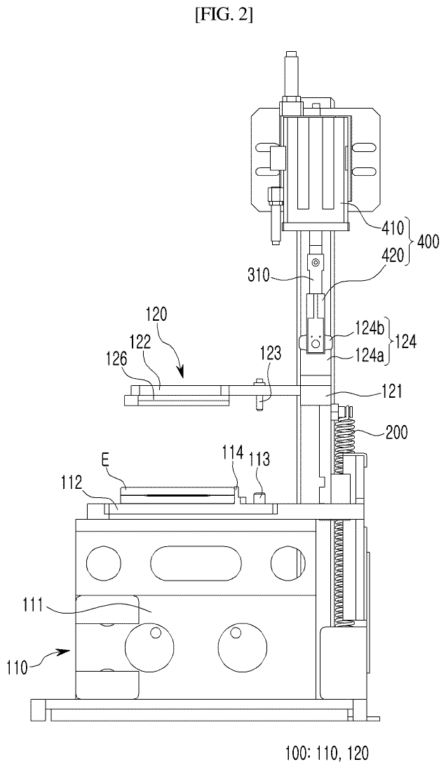

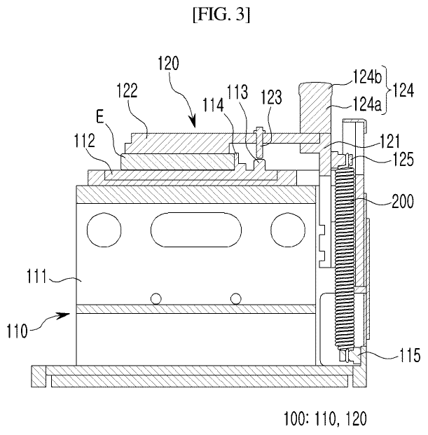

FIGS. 1 and 2 are side views of a secondary battery manufacturing device according to an exemplary embodiment of the present disclosure, and FIG. 3 is a cross-sectional view illustrating a holding device 100 according to an exemplary embodiment of the present disclosure.

Specifically, FIG. 1 is a view showing a state in which a cover plate 122 of the secondary battery manufacturing device according to an exemplary embodiment of the present disclosure elastically supports the electrode assembly E at a first position, and FIG. 2 is a view showing a state in which the cover plate 122 of the secondary battery manufacturing device according to an exemplary embodiment of the present disclosure has moved to a second position, releasing the pressed support for the electrode assembly E.

Referring to FIGS. 1 to 3, the secondary battery manufacturing device according to various embodiments of the present disclosure may include the holding device 100, an elastic member 200, a driving unit 400 and a sensing member 300.

The secondary battery manufacturing device may include the holding device 100 configured to elastically support the electrode assembly E, the elastic member 200 disposed on one side of the holding device 100 to apply an elastic force to the holding device 100, and a first sensing member 310 configured to detect the elastic force of the elastic member 200.

The secondary battery manufacturing device may include the holding device 100 which elastically supports the electrode assembly E.

The holding device 100 may be provided to elastically support or release the support of the electrode assembly E. For example, the holding device 100 may move in position according to manufacturing processes while supporting the electrode assembly E. For example, the holding device 100 may be provided to transport the electrode assembly E while elastically supporting it.

In an exemplary embodiment, the holding device 100 may include a base unit 110 and a cover unit 120.

The holding device 100 may include the base unit 110 including a base plate 112 on which the electrode assembly E is mounted, and the cover unit 120 including the cover plate 122 disposed on an upper side of the base plate 112 to elastically press the electrode assembly E.

The base unit 110 may include the base plate 112 on which the electrode assembly E is mounted, and a base body 111 positioned below the base plate 112.

In an exemplary embodiment, the base plate 112 may be disposed in a plate shape with at least a portion of its upper surface formed flat so that the electrode assembly E can be mounted thereon.

A guide part 114 may be disposed on the base plate 112 to guide the seating position of the electrode assembly E. The guide part 114 may be formed with a height that does not interfere with the elastic pressing of the electrode assembly E by the cover plate 122, which will be described below, and may be provided in any shape as long as it can contact one side of the electrode assembly E to guide it to the seating position.

A base stopper 113 may be disposed on one side of the base plate 112. The base stopper 113 may be disposed at a position that does not interfere with the seating position of the electrode assembly E on an upper surface of the base plate 112. For example, the base stopper 113 may be disposed to protrude from the upper surface of the base plate 112 by a preset height. The base stopper 113 may come into contact with the cover stopper 123, which will be described below, thereby restricting the downward movement of the cover stopper 123.

The base body 111 may be positioned below the base plate 112. The base body 111 may support the base plate 112. For example, the base body 111 may be formed integrally with the base plate 112, but it is not limited thereto.

One end of the elastic member 200 may be coupled to one side of the base body 111. A base coupling part 115, to which one end of the elastic member 200 is coupled, may be disposed on one side of the base body 111. For example, the base coupling part 115 may be disposed on one side below the base body 111, but it is not limited thereto, and the base coupling part 115 may be formed at any height that allows the elastic member 200 to exert sufficient elastic force on the cover plate 122 at the first position.

In an exemplary embodiment, the base body 111 may be provided to move in position according to the manufacturing processes of the secondary battery. For example, the base body 111 may be provided with a plurality of bearings to enable movement in position along a preset process line. For example, the movement direction of the base body 111 part may be a direction perpendicular to the up-down direction. The base body 111 may be capable of moving in position while the electrode assembly E remains elastically fixed between the base plate 112 and the cover plate 122.

The holding device 100 may include the cover unit 120. The cover unit 120 may be coupled to the base unit 110 in a manner that allows relative movement between them. The cover unit 120 may include the cover plate 122, a cover body 121, and a lifting coupling unit 124.

The cover body 121 may be coupled to the base body 111 in a manner that allows relative movement between them. For example, the cover body 121 may be coupled to the base body 111 to move up and down.

The cover body 121 may be provided to move up and down by the driving unit 400. More specifically, the cover body 121 may move upward by a driving force of the driving unit 400, and when the driving force of the driving unit 400 is released, the cover body 121 may move downward due to the elastic force exerted by the elastic member 200.

In an exemplary embodiment, the cover body 121 may extend vertically and be disposed to move vertically on one side of the base body 111.

The cover plate 122 may be disposed on one side of the cover body 121. The cover plate 122 may be disposed on the upper side of the base plate 112 to elastically press the electrode assembly E mounted on the base plate 112.

The cover plate 122 may elastically support the electrode assembly E through a compressive elastic force exerted by the elastic member 200.

In an exemplary embodiment, the cover plate 122 may be provided in a plate shape to be parallel to the base plate 112. The cover plate 122 may be disposed to move vertically relative to the base plate 112.

The cover plate 122 may move up and down relative to the base plate 112 to elastically press the electrode assembly E mounted on the base plate 112 or release the pressing thereon. For example, the cover plate 122 may be disposed to move between a first position where it can elastically press the electrode assembly E mounted on the base plate 112 and a second position where it can release the pressing on the electrode assembly E.

For example, the first position may be a position where a lower surface of the cover plate 122 comes into contact with an upper surface of the electrode assembly E, to press and support the electrode assembly E with a preset pressure. For example, the first position may be set at a height that allows the cover plate 122 to press and support the electrode assembly E by the elastic force of the elastic member 200 without causing damage to the electrode assembly E, while providing a sufficient pressing force for secure fixation.

For example, the second position may be a position where the pressing is released when the lower surface of the cover plate 122 is positioned with a predetermined gap from the upper surface of the electrode assembly E. Here, the second position may be a preset height based on process requirements, but it is not limited to a specific height.

The cover plate 122 may elastically support the electrode assembly E through the compressive elastic force exerted by the elastic member 200 at the first position.

A buffer member 126 may be disposed on the lower surface of the cover plate 122 to mitigate impact during the pressing process of the electrode assembly E by the cover plate 122.

A cover stopper 123 may be disposed on one side of the cover plate 122. The cover stopper 123 may be disposed on the lower surface of the cover plate 122 at a position that does not interfere with the electrode assembly E. For example, the cover stopper 123 may protrude downward from the lower surface of the cover plate 122 to a preset height. For example, the cover stopper 123 may be formed with a length that can guide the cover plate 122 to the first position, ensuring that the electrode assembly E is securely supported with sufficient pressing force as the cover plate 122 moves downward due to the elastic force exerted by the elastic member 200.

The cover stopper 123 may come into contact with the base stopper 113 disposed on the base plate 112 when the cover plate 122 moves downward, thereby restricting excessive downward movement of the cover stopper 123.

Although it is described herein that the cover stopper 123 is disposed on one side of the cover plate 122, it is not limited thereto, and the cover stopper 123 may also be disposed on one side of the cover body 121.

The lifting coupling unit 124 may be disposed on one side of the cover body 121. The lifting coupling unit 124 may be coupled to a lifting holder 420 of the driving unit 400, which will be described below, to transmit the driving force of the driving unit 400 to the cover unit 120.

For example, the lifting coupling unit 124 may protrude upward from one side of the cover body 121. The lifting coupling unit 124 may be detachably coupled to the lifting holder 420 of the driving unit 400. For example, the lifting coupling unit 124 may be inserted into the lifting holder 420 in a direction parallel to the movement direction of the base unit 110 to be coupled to the lifting holder 420. Alternatively, the lifting coupling unit 124 may be ejected from the lifting holder 420 in the direction parallel to the movement direction to position the base unit 110, thereby releasing its coupling with the lifting holder 420.

In an exemplary embodiment, the lifting coupling unit 124 may include a lifting shaft 124a connected to the cover body 121 and a lifting head 124b formed at an upper portion of the lifting shaft 124a. For example, the lifting head 124b may be formed to have a wider cross-sectional area than the lifting shaft 124a.

The lifting head 124b may be inserted into an insertion groove 425 of the lifting holder 420 by sliding in the movement direction of the base unit 110. Conversely, the lifting head 124b may be discharged from the insertion groove 425 of the lifting holder 420 by sliding in the direction opposite to the insertion direction. In other words, the lifting head 124b may be provided to pass through the insertion groove 425 of the lifting holder 420 in the movement direction of the base unit 110.

The lifting head 124b may be inserted into the insertion groove of the lifting holder 420 to be coupled to the lifting holder 420. For example, the lifting head 124b may be secured to the lifting holder 420 using a separate fastening member while being inserted into the insertion groove of the lifting holder 420.

One end of the elastic member 200 may be coupled to one side of the cover body 121. A cover coupling part 125, to which the other end of the elastic member 200 is coupled, may be disposed on one side of the cover body 121. For example, the cover coupling part 125 may be disposed on one upper side of the cover body 121, but it is not limited thereto, and the cover coupling part 125 may be formed at any height where the elastic member 200 can exert sufficient elastic force on the cover plate 122 at the first position.

The holding device 100 of the present disclosure may include the stoppers 113 and 123 including the cover stopper 123 and the base stopper 113. The holding device 100 may regulate downward movement of the cover plate 122 by the stoppers. The holding device 100 may include the stoppers 113 and 123 configured to regulate downward movement of the cover plate 122.

The stopper may restrict the downward movement of the cover plate 122 to ensure that, during descent of the cover plate 122 toward the base plate 112 to elastically support the electrode assembly E, the cover plate 122 does not exert pressure exceeding a preset pressure on the electrode assembly E due to excessive downward movement.

The secondary battery manufacturing device may include the elastic member 200 that applies an elastic force to the holding device 100 to elastically support the electrode assembly E. For example, the elastic member 200 may include a spring having a predetermined length. For example, the elastic member 200 may include a tension spring. The elastic member 200 may have one end coupled to one side of the base unit 110, and the other end coupled to one side of the cover unit 120.

The elastic member 200 is positioned between the driving unit and the cover plate 122. As the cover plate 122 moves upward relative to the base plate 112, the first sensing member 310 may detect the elastic force of the elastic member 200.

In an exemplary embodiment, the elastic member 200 may be disposed on one side of the holding device 100. The elastic member 200 may be disposed to extend vertically from one side of the holding device 100. One end of the elastic member 200 may be coupled to one side of the base unit 110, and the other end may be coupled to one side of the cover unit 120. For example, one end of the elastic member 200 may be detachably coupled to the base coupling part 115 disposed on one side of the base body 111. For example, the other end of the elastic member 200 may be detachably coupled to the cover coupling part 125 disposed on one side of the cover body 121.

While one end of the elastic member 200 is coupled to the base unit 110, the other end is coupled to the cover unit 120, thereby allowing the elastic member 200 to be elastically tensioned or compressed in response to the relative movement of the cover unit 120 with respect to the base unit 110. The elastic force resulting from the elastic deformation of the elastic member 200 may be detected by the first sensing member 310 which will be described below.

As the cover plate 122 is moved upward by the driving unit 400, the elastic member 200 may be elastically tensioned. For example, as the cover plate 122 reaches the second position by the driving force of the driving unit 400, the elastic member 200 is elastically tensioned to a length corresponding to the corresponding position. In the present disclosure, the elastic force may be detected by the first sensing member 310 while the elastic member 200 is in its tensioned state.

The elastic member 200 may be elastically compressed again when the driving force by the driving unit 400 is released. As the driving force by the driving unit 400 is released and the cover plate 122 returns to the first position, the elastic member 200 may apply an elastic force so that the cover plate 122 can elastically press downward the electrode assembly E. For example, while the cover plate 122 presses and supports the electrode assembly E in the first position, the first sensing member 310 may detect the elastic force of the elastic member 200.

For example, the elastic member 200 may be coupled to the holding device 100, allowing for easy removal and replacement, and may be detached from the holding device 100 and replaced when an alarm is generated by a controller 500, which will be described below.

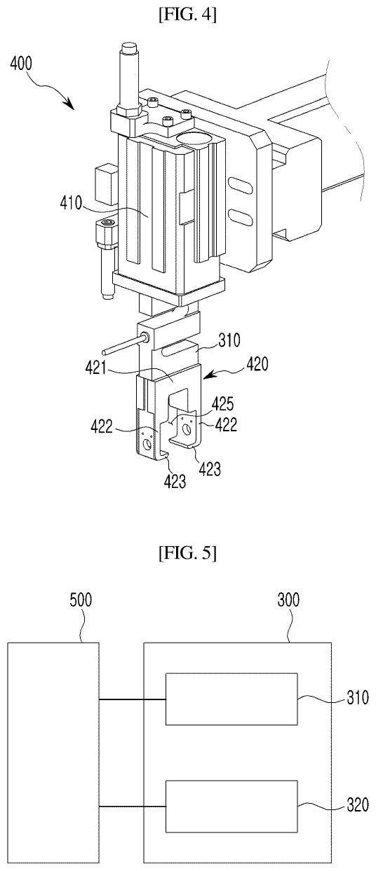

FIG. 4 is a perspective view illustrating the driving unit 400 and the first sensing member 310 according to an exemplary embodiment of the present disclosure.

Referring to FIG. 4, the secondary battery manufacturing device may include the driving unit 400 that applies a driving force to release the pressing force on the electrode assembly E with respect to the holding device 100. For example, the driving unit 400 may be disposed on the upper side of the holding device 100 to move the cover plate 122 up and down by driving. The secondary battery manufacturing device of the present disclosure may include the driving unit 400 which is disposed on the upper side of the holding device 100 to move the cover plate 122 up and down by driving.

The driving unit 400 may be disposed on the upper side of the holding device 100 and detachably coupled to the holding device 100. For example, while being coupled to the holding device 100, the driving unit 400 may apply a driving force to the cover unit 120.

The driving unit 400 may include a driving actuator 410 and the lifting holder 420 which moves up and down by the driving force of the driving actuator 410.

The driving actuator 410 may be disposed with a gap from the above-described holding device 100. For example, the driving actuator 410 may be disposed on the upper side of the holding device 100. In practice, any type of actuator capable of generating a driving force to move the lifting holder 420 and the cover unit 120 coupled to the lifting holder 420 up and down may be used as the driving actuator 410. The driving actuator 410 may apply a driving force to lift the cover unit 120 of the holding device 100, thereby releasing the pressing and support on the electrode assembly E.

A lifting holder 420 may be disposed on one side of the driving actuator 410, allowing it to move up and down by the driving force of the driving actuator 410. The lifting holder 420 may be detachably coupled to the holding device 100.

The lifting holder 420 may be detachably coupled to the lifting coupling unit 124 of the cover unit 120. By being coupled to the lifting coupling unit 124, the lifting holder 420 may transmit the driving force of the driving actuator 410 to the cover unit 120.

In an exemplary embodiment, while the holding device 100 moves in the movement direction, the lifting holder 420 may be coupled with the lifting coupling unit 124 of the cover unit 120. For example, the insertion groove 425 may be formed in the lifting holder 420, into which the lifting coupling unit 124 of the cover unit 120 may be inserted and engaged.

In an exemplary embodiment, the lifting holder 420 may include a holder body 421 connected to the driving actuator 410, a pair of grip arms 422 extending downward from the holder body 421, and grip fingers 423 extending from each of the grip arms 422 toward each other. For example, each of the grip fingers 423 may be disposed with a gap between them.

Herein, each of the grip arms 422 and each of the grip fingers 423 extending from the grip arms 422 may be collectively referred to as a grip unit. The above-described insertion groove 425 may be formed between the pair of grip units.

In an exemplary embodiment, in a process of manufacturing a secondary battery, while the base unit 110 moves along the process line, the lifting coupling unit 124 of the cover unit 120 may be inserted into the insertion groove 425 of the lifting holder 420 to be parallel to the movement direction.

For example, when the shaft of the lifting coupling unit 124 is inserted between the pair of grip fingers 423, the head of the lifting coupling unit 124 may be inserted between the pair of grip arms 422. For example, since the insertion groove 425 of the lifting holder 420 is open in the movement direction of the holding device 100, the lifting coupling unit 124 may be inserted by sliding into the insertion groove 425 of the lifting holder 420.

When the lifting coupling unit 124 is inserted into the insertion groove 425 of the lifting holder 420, the head may be caught by the grip fingers 423 because the cross-sectional area of the head is larger than that of the shaft. In this state, when the lifting holder 420 moves upward by the driving actuator 410, the head of the lifting coupling unit 124 caught by the grip fingers 423 moves along with it, thereby causing the cover unit 120 to move upward.

However, the specific structure of the lifting holder 420 described above is merely exemplary, and the present disclosure is not limited thereto. In practice, it should be understood that any structure that allows the lifting coupling unit 124 to be detachably coupled may be used. For example, in addition to the structure of the above-described grip unit, the lifting holder 420 may be detachably coupled to the lifting coupling unit 124 using a separate fastening member.

The secondary battery manufacturing device according to various embodiments of the present disclosure may include the sensing member 300. In an exemplary embodiment, the sensing member 300 may include the first sensing member 310 configured to detect an elastic force exerted on the holding device 100 by the elastic member 200, and a second sensing member 320 (see FIG. 5) configured to detect a positional misalignment of the electrode assembly E.

In an exemplary embodiment, the first sensing member 310 may be positioned between the driving actuator 410 and the lifting holder 420. The first sensing member 310 may detect the elastic force exerted on the holding device 100 by the elastic member 200. For example, the first sensing member 310 may detect the elastic force while the elastic member 200 is in the tensioned state. For example, the first sensing member 310 may include a load cell, but it is not limited thereto.

As the cover plate 122 moves upward relative to the base plate 112, the first sensing member 310 may detect the elastic force of the elastic member 200. For example, the first sensing member 310 may detect the elastic force of the elastic member 200 at the second position where the pressed support on the electrode assembly E by the cover plate 122 is released. Alternatively, the first sensing member 310 may also detect the elastic force of the elastic member 200 at the first position where the cover plate 122 elastically presses the electrode assembly E.

For example, the cover plate 122 is disposed to move from the first position where it presses the electrode assembly E to the second position where the pressing on the electrode assembly E is released. At the second position, the first sensing member 310 may detect the elastic force by the elastic member.

The first sensing member 310 may detect the elastic force of the elastic member 200 and transmit the detection result to the controller 500.

The secondary battery manufacturing device may include the second sensing member 320 configured to detect any positional misalignment of the electrode assembly E supported by the holding device 100.

The second sensing member 320 may detect any positional misalignment of the electrode assembly E, which is elastically supported by the cover plate 122 while being mounted on the base plate 112. For example, the second sensing member 320 may detect a visual image of the electrode assembly E fixedly supported by the holding device 100. For example, the second sensing member 320 may be a vision sensor including a camera, but it is not limited thereto.

In an exemplary embodiment, the second sensing member 320 may be disposed with a gap from the holding device 100 to acquire an image of the electrode assembly E. For example, the second sensing member 320 may be disposed on one side of the driving unit 400, but it is not limited thereto, and may be placed at any location capable of acquiring an image of the electrode assembly E mounted on the base plate 112.

The second sensing member 320 may detect the positional misalignment of the electrode assembly E and transmit the detection result to the controller 500.

FIG. 5 is a block diagram illustrating the operational relationship between some components according to an exemplary embodiment of the present disclosure;

Referring to FIG. 5, the secondary battery manufacturing device in the exemplary embodiment may include the controller 500. The controller 500 may receive a signal regarding the detection result detected by the sensing member 300. For example, the controller 500 may monitor the detection results by the first sensing member 310 and the second sensing member 320. The secondary battery manufacturing device may include the controller 500 configured to monitor the detection result by the first sensing member 310.

The controller 500 may receive a signal regarding the elastic force of the elastic member 200, which is detected by the first sensing member 310.

The controller 500 may compare the signal regarding the elastic force received from the first sensing member 310 with a preset elastic force management standard to determine whether an abnormality such as a functional or positional abnormality occurs in the elastic member 200. For example, if the detection result by the first sensing member 310 is lower than the preset elastic force management standard, the controller 500 may determine that the support force provided by the elastic member 200 to the holding device 100 is insufficient.

The controller 500 may compare the elastic force of the elastic member 200, which is detected by the first sensing member 310, with the preset elastic force management standard and generate an alarm indicating whether an abnormality occurs in the elastic member 200. For example, if the signal for the elastic force received from the first sensing member 310 is lower than the preset elastic force management standard, the controller 500 may determine that the support force provided by the elastic member 200 to the holding device 100 is insufficient and generate an alarm to notify the operator.

Meanwhile, the controller 500 may set the above-described elastic force management standard based on the detection results from the first sensing member 310 and the second sensing member 320.

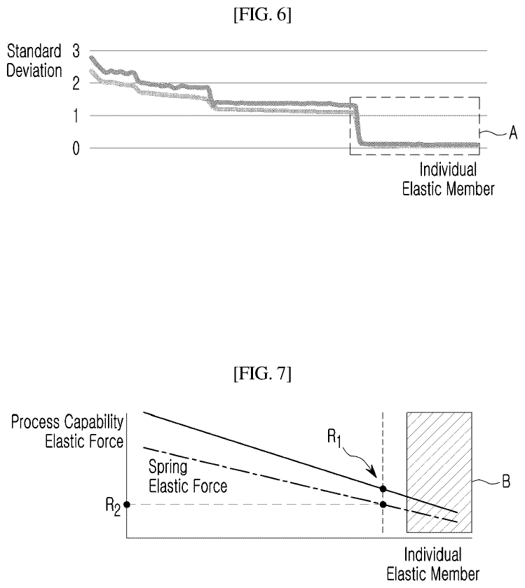

FIG. 6 is a graph illustrating the standard deviation of result data detected by the second sensing member 320 for each elastic member 200.

In FIG. 6, the detection result data from the second sensing member 320 for a plurality of elastic members 200 with different elastic forces were used to confirm the distribution of positional misalignment data of the electrode assembly E in relation to the elastic force of the elastic member 200. As the detection result data from the second sensing member 320, results obtained by separately detecting the positional misalignment based on the positions of the cathode and the anode in the electrode assembly were used.

For example, the horizontal axis in FIG. 6 represents the elastic forces of each elastic member 200. In FIG. 5, it can be observed that the standard deviation of electrode misalignment varies depending on the elastic force of the elastic member 200, which may result in differences in process capability. Further, in FIG. 6, it can be observed that when the elastic member 200 has a relatively high elastic force (e.g., see section A of FIG. 5), the standard deviation for electrode misalignment is low, thereby ensuring stable process capability.

FIG. 7 is a graph illustrating the correlation between the detection result data from the first sensing member 310 and the detection result data from the second sensing member 320 for the plurality of elastic members 200 with different elastic forces. The horizontal axis in FIG. 7 represents individual elastic members 200.

As shown in FIG. 6, the controller 500 may set an electrode misalignment standard (e.g., R1 of FIG. 7) based on the detection result data from the second sensing member 320. Using this standard, the elastic force of the elastic member 200 that meets the electrode misalignment standard may be set as an elastic force management standard (e.g., R2 of FIG. 7).

For example, the controller 500 may define a section where the dispersion of the detection result data from the second sensing member 320 is lower than a certain standard, and set it as the electrode misalignment standard.

For example, the controller 500 may also define a section before an occurrence of a defect related to electrode misalignment, based on the dispersion of the detection result data from the second sensing member 320, and set it as the electrode misalignment standard. For example, by setting the section before the occurrence of a defect related to electrode misalignment as the management standard, the controller 500 may generate an alarm in advance before an abnormality occurs in the elastic member 200, and predict the likelihood of a defect occurring in the product.

In FIG. 7, it can be observed that the process defect rate rapidly increases for the secondary battery manufacturing device which uses the elastic member 200 corresponding to a section that falls short of the set electrode misalignment standard and/or elastic force management standard (e.g., see section B of FIG. 7).

In an exemplary embodiment, the controller 500 may compare the elastic force management standard, as set above, with the current elastic force of the elastic member 200, which is detected by the first sensing member 310, to determine whether an abnormality occurs in the elastic member 200, then if an abnormality occurs, the controller 500 may generate an alarm to notify the operator.

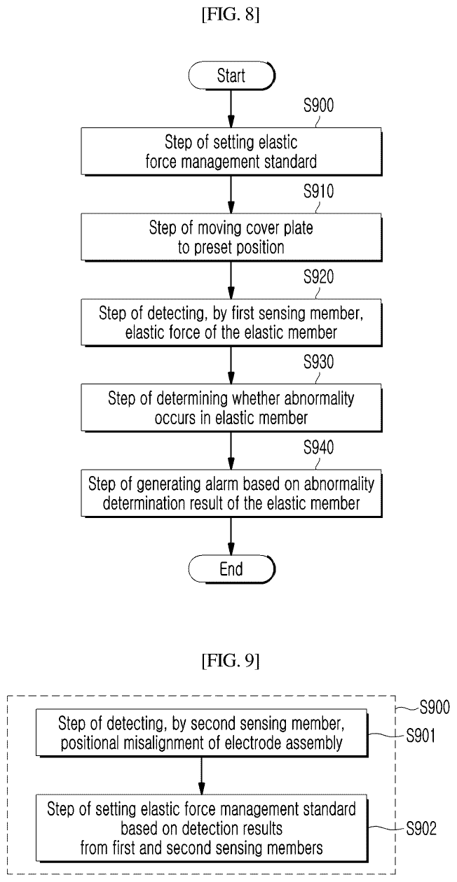

FIGS. 8 and 9 are flowcharts illustrating sequences of a secondary battery manufacturing method according to various embodiments of the present disclosure.

Referring to FIGS. 8 and 9, the secondary battery manufacturing method of the present disclosure may include a step (S900) of setting an elastic force management standard. In an exemplary embodiment, this step may be performed before a step (S930) of determining whether an abnormality occurs in the elastic member 200, which will be described below.

In the exemplary embodiment, the step (S900) of setting the elastic force management standard may further include a step (S901) of detecting, by the second sensing member 320, the positional misalignment of the electrode assembly E elastically supported by the holding device 100, and a step (S902) of setting, by the controller 500, the elastic force management standard based on the detection results from the first sensing member 310 and the second sensing member 320.

The secondary battery manufacturing method according to an exemplary embodiment may include a step (S910) of moving, by the driving unit 400, the cover plate 122 of the holding device 100 to a preset position. For example, in this step, the cover plate 122 may move from the first position where it elastically presses and supports the electrode assembly E to the second position where it releases the pressing on the electrode assembly E. During this step, the elastic member 200 may be tensioned as the cover plate 122 is moved.

The secondary battery manufacturing method may include a step (S920) of detecting, by the first sensing member 310, the elastic force of the elastic member 200 which is tensioned according to the movement of the cover plate 122. For example, in this step, the elastic force of the elastic member 200 may be detected while the cover plate 122 is in the first position. In addition, during this step, a signal regarding the elastic force detected by the first sensing member 310 may be transmitted to the controller 500.

The secondary battery manufacturing method of the present disclosure may include a step (S930) of comparing, by the controller 500, the detection result detected by the first sensing member 310 with the preset elastic force management standard to determine whether an abnormality occurs in the elastic member 200.

In addition, the secondary battery manufacturing method may further include a step (S940) of generating, by the controller 500, an alarm based on the abnormality determination result of the elastic member 200. In an exemplary embodiment, this step also enables the secondary battery manufacturing device to detect a decrease in the fixing force of the elastic member 200 and provide an alarm according to preset elastic force management standard, thereby preventing a fixing failure of the holding device 100 in advance.

That is, in the secondary battery manufacturing device of the present disclosure, the first sensing member 310 is positioned between the driving unit 400 and the holding device 100. Through this, by detecting the elastic force of the elastic member 200, which applies the elastic pressing force to the holding device 100, defects caused by abnormalities in the elastic member 200 during the fixation of the electrode assembly E may be prevented.

As described above, the present disclosure discloses the secondary battery manufacturing device having a structure in which the driving unit 400 and the holding device are detachably coupled with each other, and the first sensing member 310 is mounted on the driving unit 400. Therefore, in the manufacturing process of the secondary battery, a plurality of holding devices 100 are sequentially moved and coupled to the driving unit 400, thereby enabling the detection and determination of abnormalities in the elastic member 200 used in each holding device 100.

In the above, although the embodiments of the present disclosure have been described with all components combined in one or operating in combination, the present disclosure is not limited to these embodiments. Within the scope of the purpose of the present disclosure, all components may be selectively combined in one or more and operated accordingly. Unless otherwise defined, all terms including technical or scientific terms have the same meaning as generally understood by those skilled art to which the present disclosure pertains. Commonly used terms, such as terms defined in a dictionary, should be interpreted in accordance with the contextual meaning of the related art, and shall not be interpreted in an idealized or excessively formal meaning, unless explicitly defined in the present disclosure.

The description is merely illustrative of the technical idea of the present disclosure, and those skilled art to which the present disclosure pertains will appreciate that various modifications and variations are possible without departing from the essential characteristics of the present disclosure. Therefore, the embodiments disclosed in the present disclosure are intended to describe the technical idea of the present disclosure, and are not intended to limit the same, as well as the scope of the technical idea of the present disclosure is not limited to these embodiments. It should be understood that the protective scope of the present disclosure is interpreted by the claims below, and all technical ideas within the equivalent range are included in the scope of the present disclosure.

What is claimed is:

1. A device for manufacturing a secondary battery comprising:
a holding device configured to elastically support an electrode assembly;
an elastic member which is disposed on one side of the holding device to apply an elastic force to the holding device; and
a first sensing member configured to detect an elastic force applied by the elastic member.

2. The device for manufacturing a secondary battery according to claim 1, wherein the holding device comprises:
a base unit including a base plate on which the electrode assembly is mounted; and
a cover unit including a cover plate which is disposed on an upper side of the base plate to elastically press the electrode assembly.

3. The device for manufacturing a secondary battery according to claim 2, wherein the cover plate is disposed to move vertically relative to the base plate.

4. The device for manufacturing a secondary battery according to claim 2, wherein the elastic member has one end coupled to one side of the base unit, and the other end coupled to one side of the cover unit.

5. The device for manufacturing a secondary battery according to claim 2, wherein the elastic member comprises a tension spring.

6. The device for manufacturing a secondary battery according to claim 3, wherein the holding device comprises a stopper configured to limit downward movement of the cover plate.

7. The device for manufacturing a secondary battery according to claim 2, wherein the cover plate is disposed to move between a first position where it presses the electrode assembly and a second position where it releases the pressing on the electrode assembly, and
the first sensing member detects the elastic force of the elastic member at the second position.

8. The device for manufacturing a secondary battery according to claim 2, further comprising a driving unit disposed on an upper side of the holding device to move the cover plate up and down by driving.

9. The device for manufacturing a secondary battery according to claim 8, wherein the elastic member is positioned between the driving unit and the cover plate, and
the first sensing member detects the elastic force of the elastic member as the cover plate moves upward relative to the base plate.

10. The device for manufacturing a secondary battery according to claim 2, wherein the cover plate elastically supports the electrode assembly through a compressive elastic force exerted by the elastic member.

11. The device for manufacturing a secondary battery according to claim 2, wherein the holding device is configured to transport the electrode assembly while elastically supporting it.

12. The device for manufacturing a secondary battery according to claim 2, further comprising a controller configured to monitor results detected by the first sensing member.

13. The device for manufacturing a secondary battery according to claim 12, wherein the controller compares the elastic force of the elastic member detected by the first sensing member, with a preset elastic force management standard and generates an alarm indicating whether an abnormality occurs in the elastic member.

14. The device for manufacturing a secondary battery according to claim 13, further comprising a second sensing member configured to detect a positional misalignment of the electrode assembly supported by the holding device.

15. The device for manufacturing a secondary battery according to claim 14, wherein the controller sets the elastic force management standard based on the detection results from the first sensing member and the second sensing member.

16. A method for manufacturing a secondary battery comprising:
moving, by a driving unit, a cover plate of a holding device to a preset position;
detecting, by a first sensing member, an elastic force of an elastic member tensioned according to the movement of the cover plate;
comparing, by a controller, a detection result detected by the first sensing member with a preset elastic force management standard to determine whether an abnormality occurs in the elastic member.

17. The method for manufacturing a secondary battery according to claim 16, further comprising detecting, by a second sensing member, a positional misalignment of the electrode assembly elastically supported by the holding device.

18. The method for manufacturing a secondary battery according to claim 17, further comprising setting, by the controller, the elastic force management standard based on the detection results from the first sensing member and the second sensing member.

19. The method for manufacturing a secondary battery according to claim 16, further comprising generating, by the controller, an alarm based on the abnormality determination result of the elastic member.
